(19) United States
(12) Patent Application Publication
(10) Pub. No.: US 2009/0311069 A1
(43) Pub. Date: Dec. 17, 2009

(54) INSERT NUT AND INSERT T-NUT

(75) Inventor: Yutaka NAGAYAMA, Kishiwada-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nagayama Electric Co., Ltd., Osaka (JP)

(21) Appl. No.: 12/483,632

(22) Filed: Jun. 12, 2009

(30) Foreign Application Priority Data
Jun. 13, 2008 (JP) 2008-155218

(51) Int. Cl. F16B 37/00; B21K 1/64

(52) U.S. Cl. 411/104; 470/25

(57) ABSTRACT

There is provided an insert nut comprising a hollow shank in a polygonal shape. A metal plate is provided. The metal plate has a first region. The first region has a rectangular shape having a horizontal direction and a vertical direction. The first region is pressed to form a plurality of convexes discontinuously aligned. The convexes are not formed at bend strips parallel to the vertical direction. The press process can be done by using, e.g., a die and a punch. The first region is bent at the bend strips to form a hollow shank. Thereby, the convexes serve as a female screw on an inner surface of the hollow shank. The hollow shank of the present invention has a cross section at a face perpendicular to an axis of the hollow shank. The cross section is polygonal.

### TECHNICAL FIELD

The present invention relates to an insert nut. In the field of the industry, an insert nut is sometimes referred to as one without a flange, and an insert t-nut is sometimes referred to as one with a flange. In this present invention, the term “insert nut” collectively includes both of the above.

### BACKGROUND

An insert nut is used for e.g., attaching a leg to a table board with a bolt. One example is disclosed by JP laid-open patent publication No. 2002-295434.

Another example is disclosed by JP laid-open patent publication No. 2007-85431 (U.S. patent application Ser. No. 11/533,521). The latter is beneficial in view of the cost because a thinner metal plate can be used. Also, the latter is beneficial because of less waste such as scrapes. The latter uses a press process instead of a screw process used in the former.

However, in the process disclosed by the latter, the convexes formed by the press can not appropriately serve as a female screw because the convexes deform at the time of bending or winding the metal plate, thereby reducing the yield of the products.

The disclosure in U.S. patent application Ser. No. 11/533,521 is incorporated as a reference in this specification.

### SUMMARY OF THE INVENTION

In view of the above, the inventor has accomplished the present invention. There is provided a method for producing an insert nut comprising a hollow shank. This method includes as follows: A metal plate is provided. The metal plate has a first region. The first region has a rectangular shape having a horizontal direction and a vertical direction. The first region is pressed to form a plurality of convexes discontinuously aligned. The convexes are discontinuous such that the convexes are not formed at bend strips parallel to the vertical direction. In other words, the discontinuous convexes makes the bend strips. The press process is carried out by using, e.g., a die and a punch. The first region is bent at the bend strips to form a hollow shank. Thereby, the convexes serve as a female screw on an inner surface of the hollow shank. The hollow shank of the present invention has a cross section perpendicular to an axis of the hollow shank. The cross section is polygonal.

In the present invention, several sets of bend strips are defined on a metal plate. The bend strips are perpendicular to one horizontal side of the metal plate. The bend strips are parallel each other. Also, several sets of lines are defined at an angle inclined to the horizontal side of the metal plate. The convexes and concaves are not formed on the bend strips. The metal plate is bent at the bend strips. The opposite vertical sides of the metal plate (first region) are connected together so as to form the hollow shank of a polygonal shape. According to the present invention, the thread ridge or thread groove formed on the inner surface of the polygonal shank of the metal plate are straight. Because no convexes or concaves are formed on the bend strip, no compression force is applied to the convexes or concaves when bending the metal plate into the hollow shank. Thus, the convexes and the concaves appropriately serve as a female screw.

In the present invention, a flange, separately provided, can be attached to one end of the hollow shank.

Alternatively, the flange can be formed with the hollow shank by processing one piece metal sheet. In order to do so, the metal plate can include a second region extended from a top side of the first region. The second region is processed into a flange of the insert nut. The second region can be a strip parallel to the horizontal direction. The strip can be provided with a plurality of notches. The notches can be provided at extending from the bend strip. The notches can open when the metal plate is bent to form a hollow shank. The notches can help processing the strip into a flange.

The metal plate can be further provided with a bridge portion for connecting the second region in a strip shape. The strip can be extended in the horizontal direction, and the strip is processed into an engaging hole in which a tool is engaged to rotate the insert nut.

### BRIEF DESCRIPTION OF THE DRAWINGS

FIG. 1 illustrates a plan view of a metal plate used in the first embodiment of the present invention.

FIG. 2 illustrates a plane view of a metal plate of the first embodiment.

FIG. 3(a) illustrates a plan view of a metal plate in which a press process is applied to form convexes and concaves, and FIG. 3(b) illustrates a cross sectional view at the A-A line of FIG. 3(a).

FIG. 4 is an enlarged view of the adjoining thread ridges of the first embodiment.

FIG. 5 illustrates a perspective view of a state where the metal plate is bent at the bend strips.

FIG. 6 illustrates a perspective view of the process to attach a flange to obtain the t-nut of the first embodiment.

FIG. 7 illustrates a perspective view attaching a flange of the t-nut of the first embodiment.

FIG. 8 illustrates a perspective view of a t-nut as a second embodiment.

FIG. 9 illustrates a plan view of a metal plate used in the second embodiment.

FIG. 10(a) illustrates a plan view of a metal plate forming convexes and concaves, and FIG. 10(b) illustrates a cross-sectional view of the line B-B of FIG. 9(a).

FIG. 11 illustrates a perspective view of a state in which the second region is bent with respect to the first region.

FIG. 12 illustrates a perspective view of a state in which the metal plate is bent.

FIG. 13 illustrates a perspective view of a modification of the present invention.

FIG. 14 illustrates a perspective view of an insert nut as a third embodiment of the present invention.

FIG. 15 illustrates a perspective view of a metal plate used in the third embodiment.

FIG. 16 illustrates a perspective view of a metal plate used in the third embodiment, having a resin portion.

### DETAILED DESCRIPTION OF THE INVENTION

The present invention is described in detail based on the embodiments of the invention. A plate made of stainless steel was used in the embodiments, but the present invention is not limited thereto.

### First Embodiment

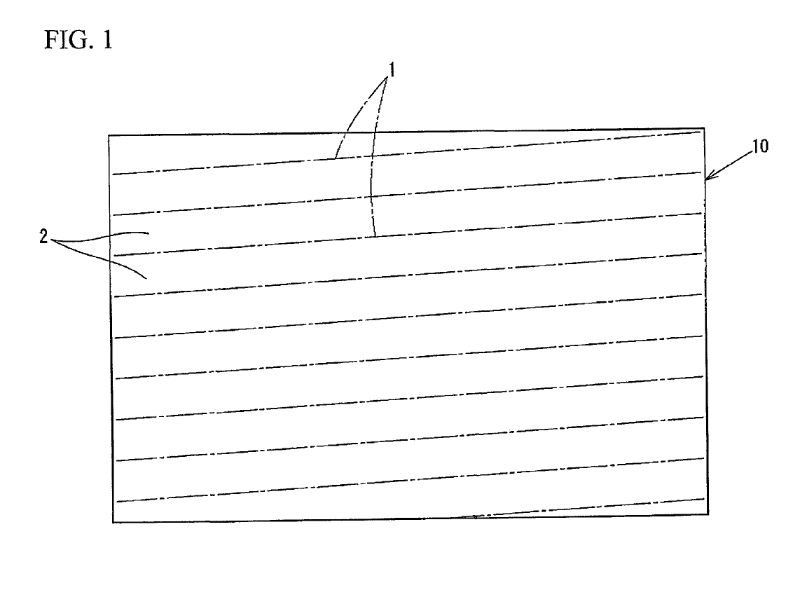

FIG. 1 illustrates a metal plate 10 used in the present invention. As illustrated in the drawing, the metal plate 10 has a rectangular shape. The longer side of the rectangle is placed horizontally in the drawing. On the front surface of the metal plate 10, several lines 1 are set up (drawn). The lines 1 are inclined against the longer side at a given angle. In the drawing, the inclined lines are shown by a dashed line. These lines 1 are drawn to form convexes which eventually serve as a thread ridge of a female screw. The lines 1 are thus “to-be-thread-ridge lines” 1. Between the lines 1, a thread groove is formed.

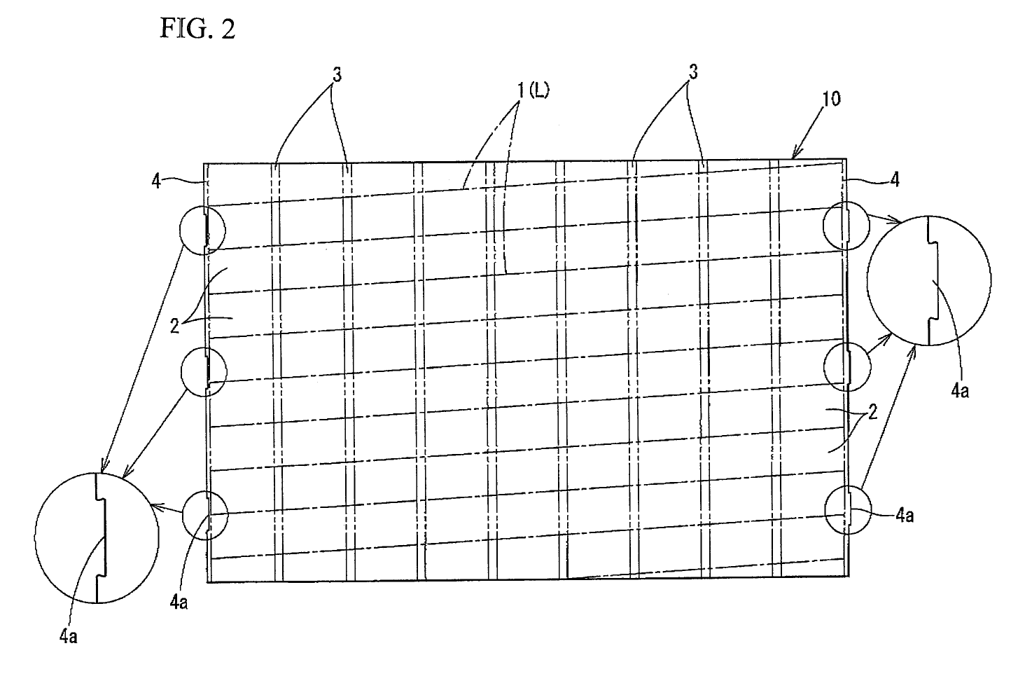

As illustrated in FIG. 2, bend strips 3 are formed. The number of the bend strips 3 is determined in order to form an enneagonal hollow shank, but the present invention is not limited to an enneagonal body.

On the shorter sides (vertical sides), a connecting portion 4 is formed. The connecting portion 4 ranges over a given width, where the to-be-thread ridge lines I is not set up (drawn). The connecting portion 4 includes an engaging part 4a as shown in the drawing.

Eight bend strips 3 are formed. The bend strips 3 are perpendicular to the longer side of the metal plate. The bend strips 3 are placed at an even interval. The connecting part 4a is illustrated in detail in FIG. 2.

Then, the metal plate 10 is applied to a press process by using a punch and a die. The punch and die can be applied or sandwiches the metal plate from the both surfaces to form the convexes and concaves.

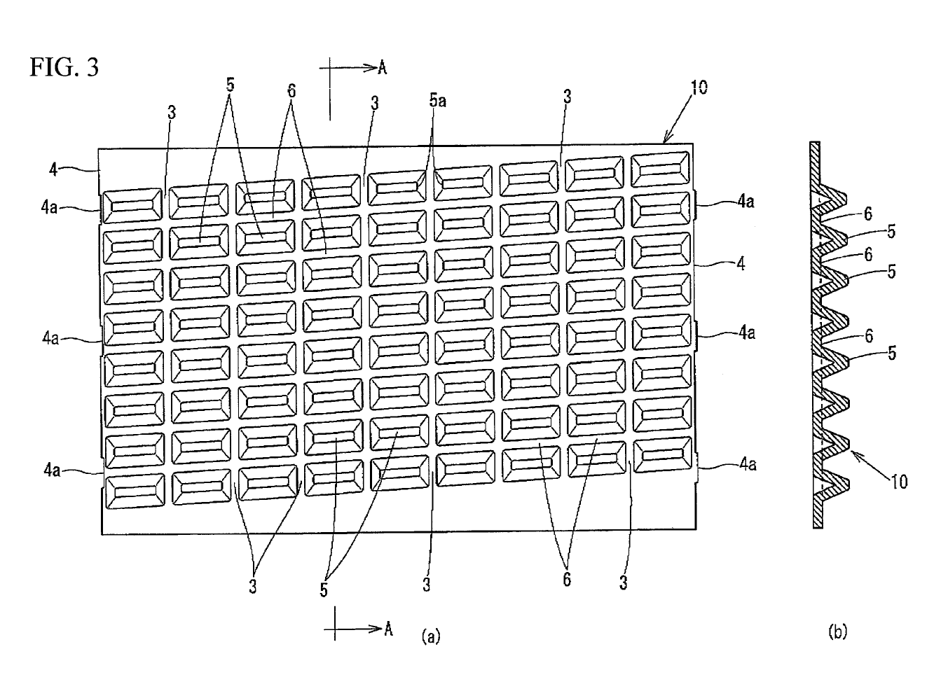

Convexes and concaves are formed as illustrated in FIG. 3,

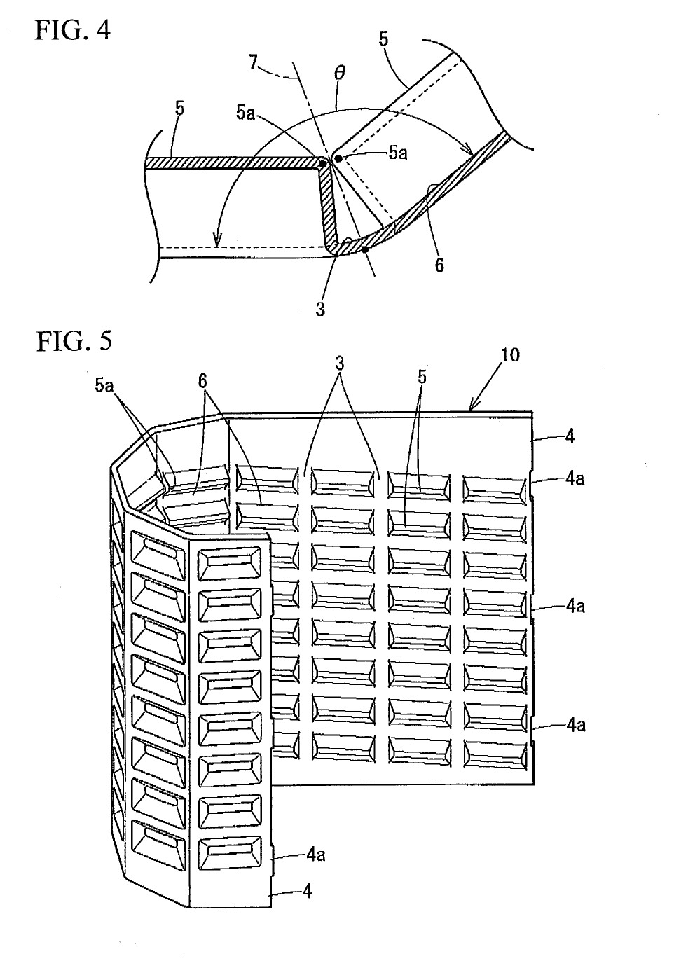

In the present invention, the convexes are formed discontinuously. Thus, adjoining thread ridges 5, 5 (edge of the thread ridge 5a) do not interfere with each other when the metal plate 10 is bent to form an enneagonal hollow shank, as illustrated in FIG. 4,

Then, the metal plate 10 is bent at the bend strips 3 as illustrated in FIG. 5. The connecting parts 4a at the connecting portions 4 connects to each other so as to form an exact enneagon hallow shank 7. The convexes and the concaves are alternatively placed on the inner surface and the outer surface of the hollow body. The convexes and the concaves serve as a female screw in the hollow shank 7. Thus, the female screw is composed of the thread ridge 5 and the thread groove 6.

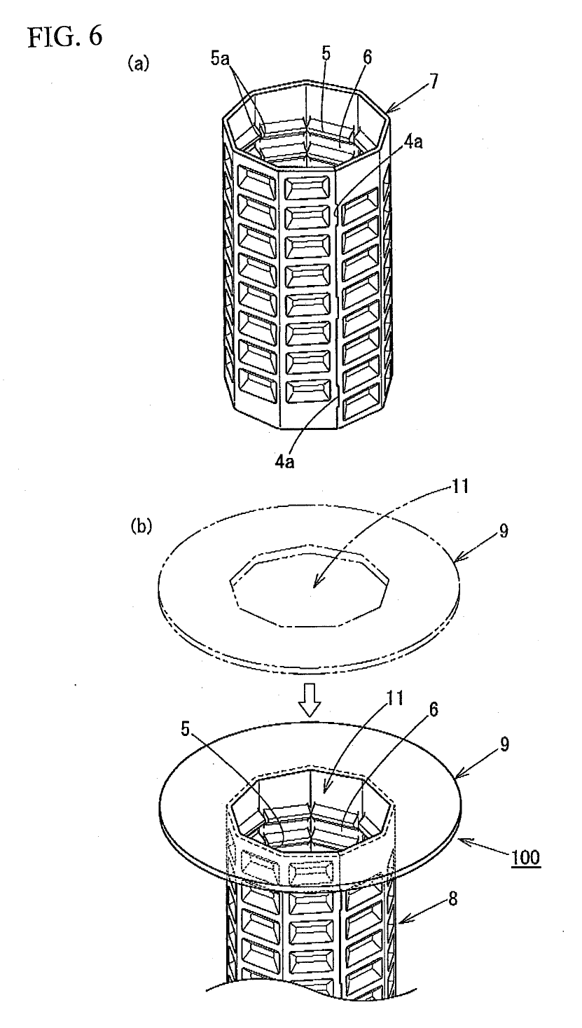

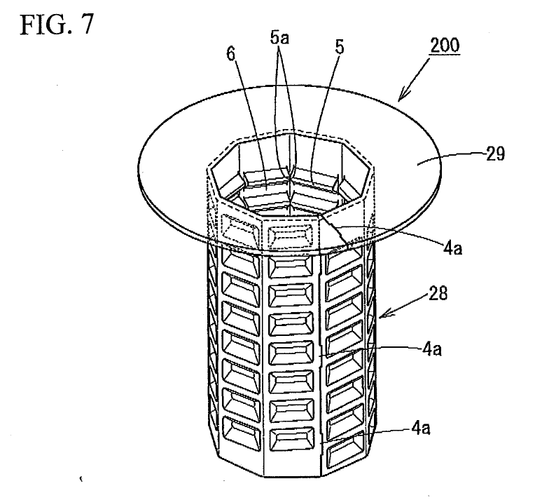

Then, as illustrated in FIGS. 6 and 7, a flange 9, separately provided, is attached to one end of the hollow shank 7.

The flange 9 has a doughnut shape having an outer portion shaped in a circle body with an enneagon hole 11 at the center thereof. The enneagon hole 11 corresponds to the outer surface of the hollow shank 7. The hole 11 is fitted with one end of the hollow portion 7. The flange 9 and the hollow shank can be fixed by an adhesive or welding. The flange 9 may have a projection such as a claw to engage the t-nut 100 with a fixed material such as a table board.

In this embodiment, the hollow shank 7 is formed as explained above. The metal plate 10 is bent and formed into an enneagon body. The convexes, serving as a thread ridge 5, are discontinuously formed on the inner surface of the hollow shank 7. The metal plate is bent at predetermined portions, that is, the bend strip 3. Thus, the thread ridge 5 is extended straight. No compression force or stress is applied to the convexes at the time of bending the metal plate.

The convex can be designed to avoid interference with the adjacent convexes. Namely, the convexes can be formed not to deform the shape when the metal plate is bent.

### Second Embodiment

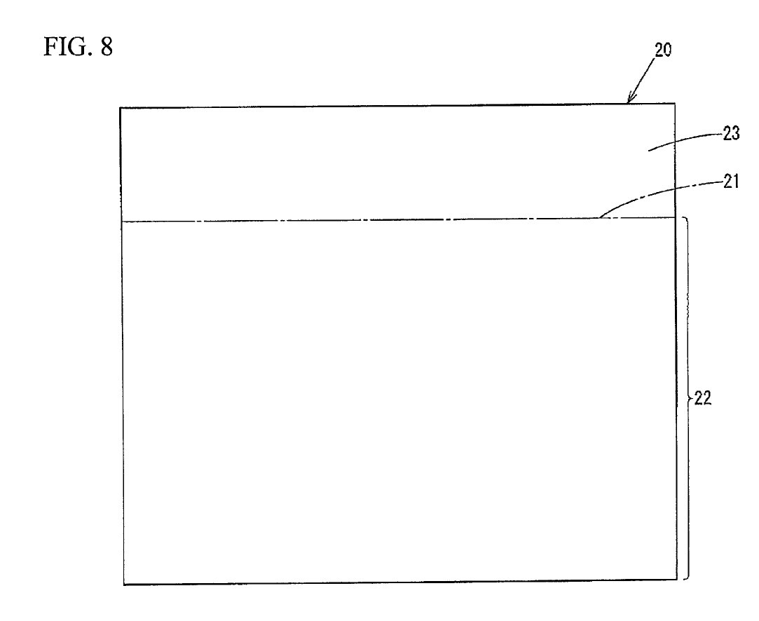

FIG. 8 illustrates a second embodiment of the present invention. The same elements as the first embodiment are shown by the same reference numbers. The t-nut 200 has a flange 28 integrated with the hollow shank 27.

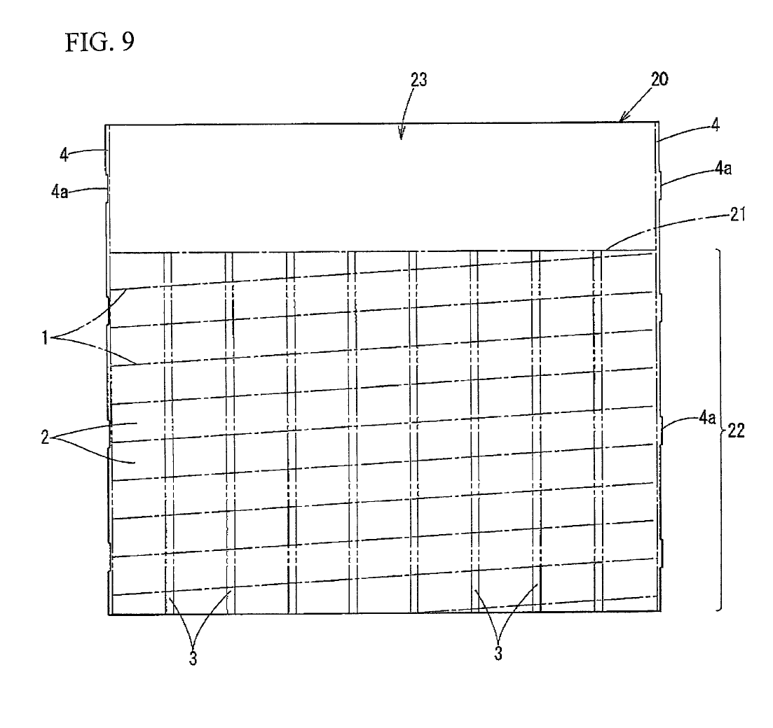

As illustrated in FIG. 9, a rectangular metal plate 20 is divided into a first region 22 and a second region 23 by a dividing line 21. The dividing line 21 is parallel to one side (horizontal side) of the rectangle. The first region 22 eventually becomes a hollow shank with a female screw thereinside. The second region 23 becomes a flange 28.

As illustrated in FIG. 9, the first region 22 is set up to have lines 1 and bend strips 3. The connecting portion 4 is formed both in the first and second regions.

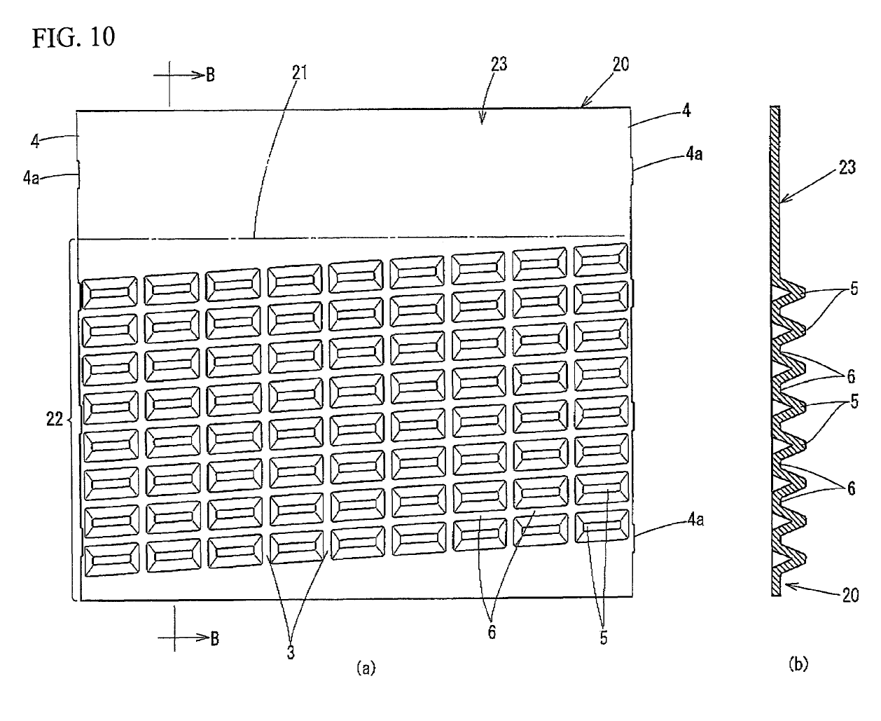

A die and a punch are applied on the both surfaces of the first region 22. Neither convexes nor concaves are formed on the bend strips 3, as illustrated in FIGS. 9 and 10.

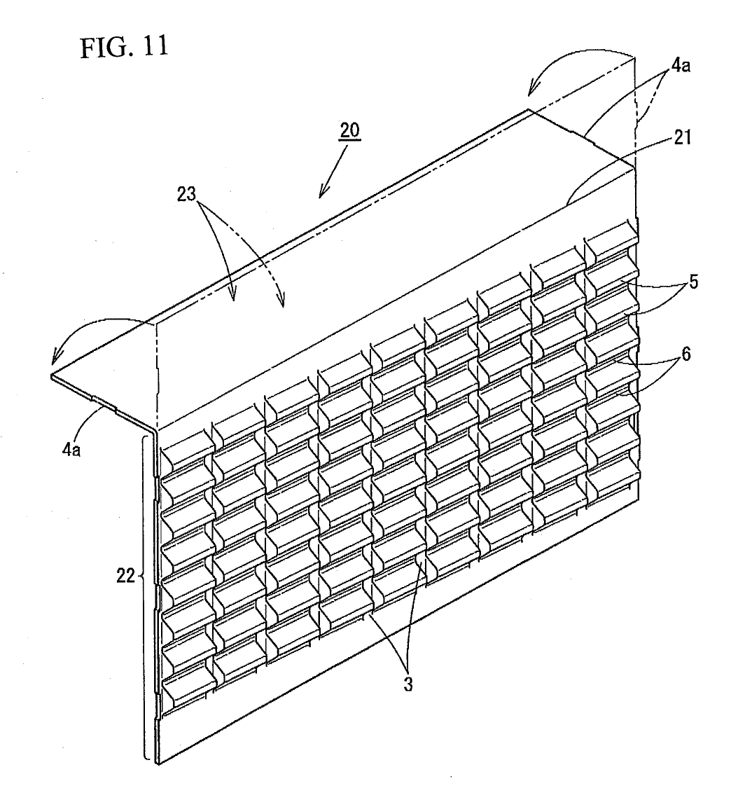

As illustrated in FIG. 11, the first region 22 forms the thread ridge 5 and the thread groove 6. The second region 23 is bent at the dividing line 21 at the right angle with respect to the first region 22.

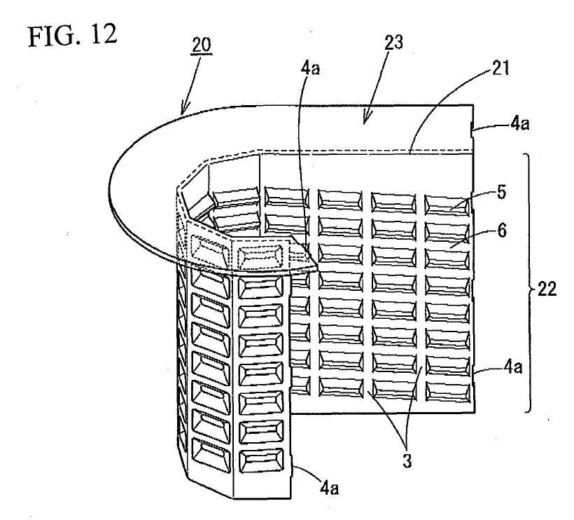

Finally, as illustrated in FIG. 12, the first region 22 is bent at the bend strips 3. The connecting parts 4a are used for connecting each other. Thus, an enneagon hollow body can be obtained.

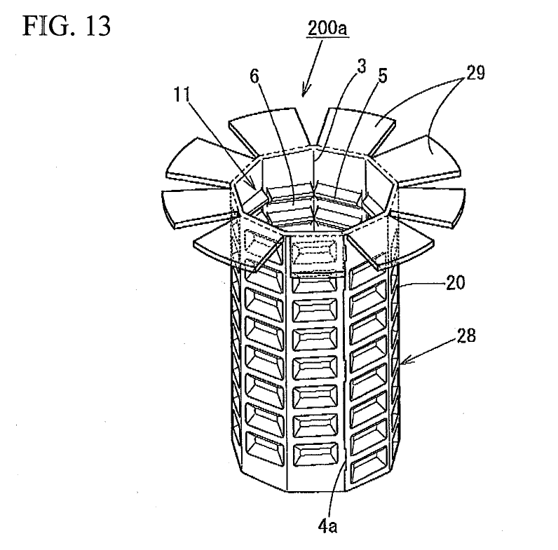

A further modification is illustrated in FIG. 13. Notches are provided on the second region 23. The notches are formed by cutting second region. The notches are provided at portions corresponding as extending from the bend strips 3. This modification reduces the stress applied to the second region when it is processed into a flange. The flange 29, as processed, is illustrated in FIG. 13.

### Third Embodiment

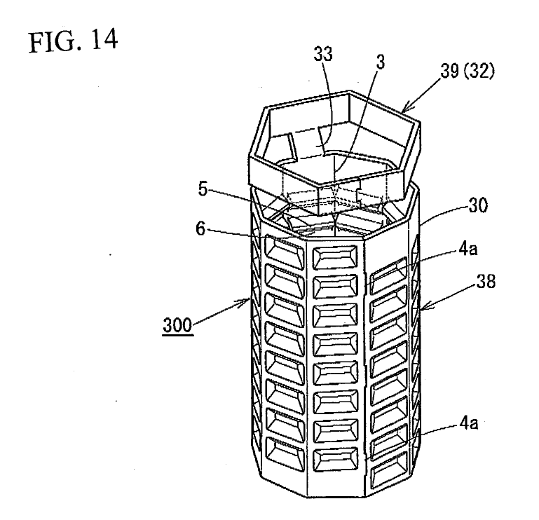

FIG. 14 illustrates a third embodiment of the present invention. The same elements are shown by the same reference numbers as the embodiments previously explained. As illustrated in FIG. 14, the insert nut 300 has an engaging portion 34 integrated with the hollow shank 37. The engaging portion is engaged with a tool for rotating the insert nut 300.

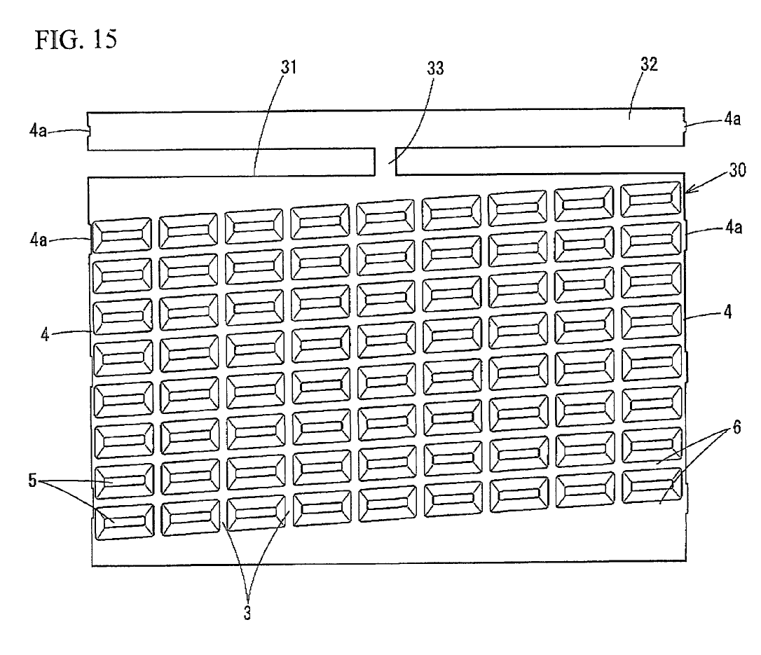

In order to form the hollow shank 37, a press process is applied to the both surfaces of the metal plate. The metal plate 30 used in this embodiment is illustrated in FIG. 15.

The metal plate 10 of this embodiment has a rectangle 31 having a band portion 32 via a bridge portion 33 extended from the top longer side of the rectangle 31. The band portion 32 is parallel to the longer side of the rectangle. The band portion 32 becomes an engaging flange 34 for rotating the insert nut 300 by using a tool.

A press process is applied to the rectangle 31 to form convexes and concaves, which eventually become a female screw composed of a thread ridge 5 and a thread groove 6. The detailed process is explained before. The hollow shank has a cross section of an exact enneagon in the same manner as the previous embodiment.

The insert nut 300 of the third embodiment does not use a screwing process. According to the present invention, a high yield of the products can be obtained. The female screw, as formed in the hollow shank, is not deformed, and appropriately serves as intended purposes.

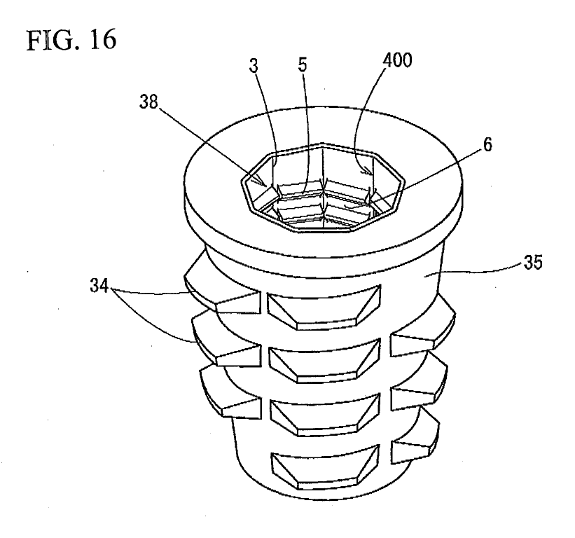

As illustrated in FIG. 16, a resin portion 35 can be additionally formed to surround the insert nut 300 to form a nut 400. The outside of the resin portion 35 has a female screw portion 34 to engage it with the wall material when it is installed into a wall.

In each of the embodiments, the cross section of the hollow shanks 7, 28, 38 at a face perpendicular to the axis thereof is enneagonal. However, the present invention is not limited to an enneagonal shape. The hollow portion can be octagonal or decagonal. The hollow portion can be also hexagonal or heptagonal.

What is claimed is:

1. A method for producing an insert nut comprising a hollow shank, comprising:
providing a metal plate comprising a first region, the first region having a rectangular shape having a horizontal direction and a vertical direction,
pressing the first region to form a plurality of convexes discontinuously aligned, wherein the convexes are not formed at bend strips parallel to the vertical direction, and
bending the first region at the bend strips to form a hollow shank, the convexes serving as a female screw on an inner surface of the hollow shank,
wherein the hollow shank has a cross section perpendicular to an axis of the hollow shank, and
wherein the cross section is polygonal.

2. A method according to claim 1, further comprising a flange attached to one end of the hollow shank.

3. A method according to claim 1, wherein the metal plate further comprises a second region extended from a top side of the first region; wherein the second region is processed into a flange.

4. An insert nut according to claim 3, wherein the second region is a strip parallel to the horizontal direction, wherein the strip has a plurality of notches as extending from the bend strips.

5. An insert nut according to claim 1, wherein the metal plate further comprises a second region shaped in a strip extended from a top side of the first region via a bridge portion; wherein the strip is extended in the horizontal direction, wherein the strip is processed into an engaging hole for a tool for rotating the insert nut.

6. An insert nut comprising a hollow shank obtained by winding a metal plate,
wherein the metal plate comprises a first region;
wherein the hollow shank has a cross section at a face perpendicular to an axis of the hollow shank,
wherein the cross section is polygonal,
wherein the first region has a rectangular shape having a horizontal direction and a vertical direction;
wherein the first region is pressed to form a plurality of convexes discontinuously aligned,
wherein the convexes are not formed at bend strips parallel to the vertical direction;
wherein the first region is bent at the bend strips to form the hollow shank;
wherein the convexes serve as a female screw on an inner surface of the hollow shank.

7. An insert nut according to claim 1, further comprising a flange attached to one end of the hollow shank.

8. An insert nut according to claim 1, wherein the metal plate further comprises a second region extended from a top side of the first region; wherein the second region is processed into a flange of the insert nut.

9. An insert nut according to claim 3, wherein the second region is a strip parallel to the horizontal direction, wherein the strip has notches as extending from the bend strips.

10. An insert nut according to claim 1, wherein the metal plate further comprises a second region shaped in a strip extended from a top side of the first region via a bridge portion; wherein the strip is extended in the horizontal direction, wherein the strip is processed into an engaging hole for a tool for rotating the insert nut.
